(19) United States
(12) Patent Application Publication
(10) Pub. No.: US 2015/0243409 A1
(43) Pub. Date: Aug. 27, 2015

(54) INSULATED WINDING WIRE CONTAINING SEMI-CONDUCTIVE LAYERS

(71) Applicant: Essex Group, Inc., Atlanta, GA (US)

(72) Inventors: Bogdan Gronowski, Fort Wayne, IN (US); Allan R. Knerr, Fort Wayne, IN (US)

(21) Appl. No.: 14/630,686

(22) Filed: Feb. 25, 2015

Related U.S. Application Data
(60) Provisional application No. 61/944,225, filed on Feb. 25, 2014.

(51) Int. Cl. H01B 7/02; H01B 13/00; H01B 13/06

(52) U.S. Cl. CPC H01B 7/0225; H01B 13/06; H01B 13/0036

(57) ABSTRACT

An insulated winding wire may include a conductor and a plurality of adjacent layers of semi-conductive material formed around the conductor. First and second layers of semi-conductive material included in the plurality of adjacent layers may have different conductivities. For example a first layer of semi-conductive material may have a first conductivity, and a second layer of semi-conductive material may have a second conductivity lower than the first conductivity. Additionally, at least one layer of insulation material may be formed around the conductor, for example, on the second layer of semi-conductive material.

### CROSS-REFERENCE TO RELATED APPLICATION

This application claims priority to U.S. Provisional Application No. 61/944,225, filed Feb, 25, 2014 and entitled “Insulated Winding Wire Containing One or More Semi-Conductive and/or Conductive Layers”, the contents of which is incorporated by reference herein in its entirety.

### TECHNICAL FIELD

Embodiments of the disclosure relate generally to insulated winding wire or magnet wire and, more particularly, to winding wire formed with a conductor and semi-conductive layers formed around the conductor.

### BACKGROUND

Magnetic winding wire, also referred to as magnet wire, is used in a multitude of electrical devices that require the development of electrical and/or magnetic fields to perform electromechanical work, Examples of such devices include electric motors, generators, transformers, actuator coils, and so on. Typically, magnet wire is constructed by applying insulation around a metallic conductor, such as a copper, aluminum, or metal alloy conductor. The conductor typically is drawn, rolled, or conformed to obtain a generally rectangular or circular cross-section. The insulation is typically formed as a single or multilayer structure that provides dielectric separation between the conductor and other conductors or surrounding structures that are at different electrical potentials. As such, the insulation is designed to provide a required dielectric strength to prevent electrical breakdowns in the insulation.

However, when a magnet wire conductor is formed, the conductor's surface often includes imperfections, such as burs, dents, slivers of conductive material, inclusions of foreign material, etc. Similarly, in certain applications (e.g., a motor application), a magnet wire may be placed in a grounded structural device or component (e.g., a laminated stator, etc.) or in proximity to other components having different electrical potential (e.g., a winding of a different phase, etc.). Imperfections along the conductor's surface and/or imperfections along an outer surface of another device or component in proximity to the magnet wire may lead to non-uniform local electrical fields within the insulation of the magnet wire. These non-uniform electrical fields may exceed the permissible electrical stress in the insulation and may subsequently lead to the initiation and subsequent development of partial discharge, which may later progress to complete breakdowns in the magnet wire insulation, Accordingly, an opportunity exists for improved winding wire or magnet wire that incorporates semi-conductive layers in order to reduce stresses on the wire insulation.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended, to limit the scope of the disclosure.

FIG. 1 is a perspective view of an example magnet wire that includes a plurality of semi-conductive layers formed around a central conductor, according to an illustrative embodiment of the disclosure.

FIGS. 2A and 2B are cross-sectional views of example magnet wires that include semi-conductive layers formed between a central conductor and magnet wire insulation, according to illustrative embodiments of the disclosure.

FIGS. 3A and 3B are cross-sectional views of example magnet wires that include semi-conductive layers formed as outermost layers, according to illustrative embodiments of the disclosure.

FIGS. 4A and 4B are cross-sectional views of example magnet wires that include both outermost semi-conductive layers and semi-conductive layers formed between a central conductor and magnet wire insulation, according to illustrative embodiments of the disclosure.

FIGS. 5 and 6 are diagrams illustrating equalizing of non-uniform electrical fields that may be achieved by the utilization of semi-conductive layer(s) incorporated into magnet wire, according to illustrative embodiments of the disclosure.

### DETAILED DESCRIPTION

Various embodiments of the present disclosure are directed to insulated winding wires, magnetic winding wires, and/or magnet wires (hereinafter referred to as “magnet wire”) that include a conductor and a plurality of layers formed around the conductor that contain semi-conductive material. According to an aspect of the disclosure, a multi-layer semi-conductive structure may be incorporated into a magnet wire. In other words, a plurality of successive semi-conductive layers may be utilized. Additionally, at least two of the plurality of semi-conductive layers may have different conductivities. For example, a first semi-conductive layer having a first conductivity may be formed such that it encounters a non-uniform electric field that may be caused by imperfections in the magnet wire or by an external structure. A second semi-conductive layer having a second conductivity lower than the first conductivity may then be formed such that it encounters the non-uniform electric field after the first semi-conductive layer.

In certain embodiments, a plurality of semi-conductive layers may be successively formed directly around a magnet wire conductor, for example, directly or a bare conductor. In other embodiments, a plurality of semi-conductive layers may be formed as outermost layers of a magnet wire. In yet other embodiments, a magnet wire may include both a first plurality of semi-conductive layers formed directly around the conductor and a second plurality of semi-conductive layers formed as outermost layers.

For purposes of this disclosure, the term “semi-conductive” refers to an electrical conductivity that is between that of a conductor (e.g., copper) and that of an insulating or dielectric material. Thus, a semi-conductive layer constitutes a layer of magnet wire having a conductivity between that of a conductor and that of an insulator. Typically, a semi-conductive layer has a volume conductivity (σ) between approximately 10⁻⁸ Siemens per centimeter (S/cm) and approximately 10³ S/cm at approximately 20 degrees Celsius (° C.). In certain embodiments, a semi-conductive layer has a conductivity between approximately 10⁻⁶ S/cm and approximately 10² S/cm at approximately 20° C. As such, a semi-conductive layer typically has a volume resistivity (ρ) between approximately 10⁻³ Ohm centimeters (Ω·cm) and approximately 10⁸ Ω·cm at approximately 20° C. In certain embodiments, a semi-conductive layer may have a volume resistivity (ρ) between approximately 10⁻² Ω·cm and approximately 10⁶ Ω·cm at approximately 20° C.

A wide variety of suitable semi-conductive materials and/or combinations of materials may be utilized as desired to form a semi-conductive layer. For example, one or more suitable semi-conductive enamels, extruded semi-conductive materials, semi-conductive tapes, and/or semi-conductive wraps may be utilized. As explained in greater detail below these semi-conductive materials may include a wide variety of constituent components and/or ingredients. For example, a semi-conductive enamel may be formed by adding any number of filler materials to a polymeric varnish.

As a result of incorporating semi-conductive layers into a magnet wire, non-uniform electric, magnetic, and/or electromagnetic fields (hereinafter collectively referred to as electric fields) may be equalized or “smoothed out.” For example, imperfections or discontinuities on the surface of a magnet wire conductor, such as burs (i.e., peaks), dents (i.e., valleys), slivers of conductive materials, foreign materials, etc., may be a source of local non-uniform electric fields. Similarly, imperfections on an electrically grounded component (e.g., a stator, motor housing, etc.) that houses the magnet wire or that is otherwise situated in relatively close proximity to the magnet wire, may lead to the creation of local non-uniform electric fields. These non-uniform fields may electrically stress the insulation (e.g., enamel, extruded insulation, insulating wraps, etc.) of an energized magnet wire. Subsequently, the local gradients of an electric field may lead to the premature deterioration of the insulation integrity and additionally may result in initiation and subsequent development of partial discharges, which may finally result in the full breakdown of the insulation. The addition of a plurality of semi-conductive layers may help to equalize or “smooth out” the non-uniform electric fields, thereby reducing local stress in the insulation. As a result, the electrical performance of the magnet wire may be improved. This enhancement may manifest itself in relatively short-term performance improvements, such as an improvement in the results of voltage breakdown tests and/or partial discharge inception voltage. Additionally, this enhancement may improve the long-term performance of the insulation, as it may “neutralize” the sources fur the creation of high gradient local electric fields and subsequently slow down the aging process of the insulation and extend the life expectancy of the magnet wire.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

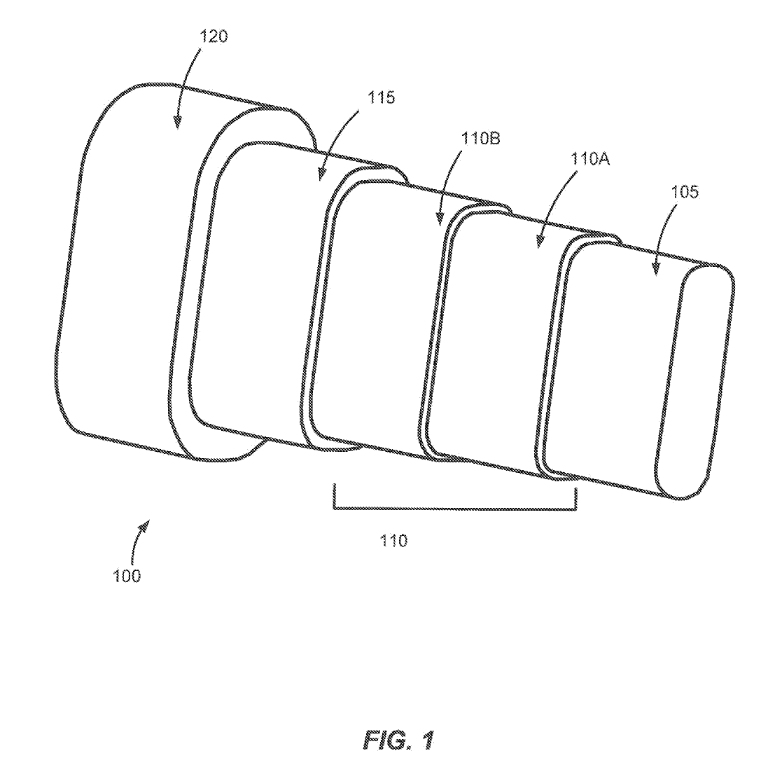

With reference to FIG. 1, a perspective view of an example magnet wire 100 that includes a plurality of semi-conductive layers is illustrated in accordance with an example embodiment of the disclosure. The magnet wire 100 may include a central conductor 105, and a multi-layer semi-conductive structure 110 may be formed around the central conductor 105. The semi-conductive structure 110 may include any number of layers, such as the two layers 110A, 110B illustrated in FIG. 1. As shown, the semi-conductive structure 110 may be formed directly around the central conductor 105; however, in other embodiments, the semi-conductive structure 110 may be formed as outermost layers of the magnet wire 100. In yet other embodiments, the magnet wire 100 may include a first semi-conductive structure formed directly on the central conductor 105 and a second semi-conductive structure formed as outermost layers.

With continued reference to FIG. 1, the magnet wire 100 may additionally include an insulation system, which may include any number of layers of insulation, insulating, or dielectric material. As shown, the magnet wire 100 includes an enamel structure 115 formed around the semi-conductive structure 110 and an extruded thermoplastic layer 120 formed around the enamel structure 115. In other embodiments, a magnet wire insulation system may include any number of suitable insulation layers and/or types of insulation material including, but not limited to, one or more enamel layers, one or more extruded thermoplastic layers, and/or one or more suitable insulation tapes or wraps. Each of the components of the magnet 100 are described in greater detail below.

The conductor 105 may be formed from a wide variety of suitable conductive materials and or combinations of materials. For example, the conductor 105 may be formed from copper (e.g., annealed copper, oxygen-free copper, etc.), silver-plated copper, aluminum, copper-clad aluminum, silver, gold, a conductive alloy, or any other suitable electrically conductive material. Additionally, the conductor 105 may be formed with any suitable dimensions and/or cross-sectional shapes. As shown in FIG. 1, the conductor 105 may have an approximately rectangular cross-sectional. shape. For example, a cross-section of the conductor 105 may be generally rectangular with rounded comers. In other embodiments, the conductor 105 may have an approximately circular cross-sectional shape. Indeed, the conductor 105 may be formed with a wide variety of suitable cross-sectional shapes, such as a rectangular shape (i.e., a rectangle with sharp rather than rounded corners), an approximately rectangular shape, a square shape, an approximately square shape, an elliptical or oval shape, a hexagonal shape, a general polygonal shape, etc. Additionally, as desired, the conductor 105 may have corners that are rounded, sharp, smoothed, curved, angled, or otherwise formed.

Additionally, the conductor 105 may be formed with a wide variety of suitable dimensions. For example, with a rectangular or square conductor, the various sides may have any suitable lengths. Similarly, with a circular conductor, any suitable diameter may be utilized. As one non-limiting example, a rectangular conductor 105 may have longer sides with lengths between approximately 0.020 inches (508 μm) and approximately 0.750 inches (19050 μm), and shorter sides with lengths between approximately 0.020 inches (508 μm) and approximately 0.400 inches (10160 μm). As another non-limiting example, a square conductor may have sides with lengths between approximately 0.020 inches (508 μm) and approximately 0.500 inches (12700 μm). As yet another non-limiting example, a round conductor may have a diameter between approximately 0.010 inches (254 μm) and approximately 0.500 inches (12700 μm). Other suitable dimensions may be utilized as desired. Additionally, in various embodiments, the dimensions of a conductor 105 may be based at least in part upon an intended application of the magnet wire 100.

A wide variety of suitable methods and/or techniques may be utilized to form, produce, or otherwise provide a conductor 105. In certain embodiments, a conductor 105 may be formed by drawing an input material (e.g., rod stock, a larger conductor, etc.) with one or more dies in order to reduce the size of the input material to desired dimensions. As desired, one or more flatteners and/or rollers may be used to modify the cross-sectional shape of the input material before and/or after drawing the input material through any of the dies. In other embodiments, input material may be processed by one or more conform machines or devices that process the input material in order to form a conductor 105 having desired dimensions. In yet other embodiments, a conductor 105 with desired dimensions may be preformed or obtained from an external source.

Additionally, in certain embodiments, the conductor 105 may be formed in tandem with the application of a portion or all of the semi-conductive structure 110 and/or the insulation layers 115, 120. In other words, conductor formation and application of cover material may be conducted in an online or uninterrupted continuous process. In other embodiments, the conductor 105 may be formed in a first process, and formation of the semi-conductive structure 110 and one or more insulation layers 115, 120 may occur in one or more subsequent processes. In other words conductor formation and application of cover material may be conducted in an offline manner or in various steps included in an interrupted overall process. As desired, the conductor 105 may be taken up and/or wound around a spool after formation and subsequently provided as input material to one or more suitable devices that subsequently apply cover material.

The insulation structure may be formed as a single layer structure or as a multi-layer structure. Additionally, each insulation layer may include any suitable insulation material and/or combinations of insulation materials. For example, the insulation structure may include one or more enamel layers, one or more extruded insulation layers, and/or one or more insulating tapes or wraps. In the event in which the insulation structure includes a plurality of layers, any number of layers may be utilized. In certain embodiments, the layers may be formed from the same material and/or combination of materials, For example, a plurality of enamel layers may be formed, and each enamel layer may be formed from the same polymeric material. In other embodiments, at least two of the insulation layers may be formed from different materials. For example, different enamel layers may be formed from different polymeric materials. As another example, one or more layers may be formed from enamel while another layer is formed from a suitable tape or extruded insulation material. Indeed, a wide variety of different combinations of material may be utilized to form an insulation system. In certain embodiments, the selection of insulation material(s) and/or the arrangement of insulation layer(s) may be based at least in part on application requirements, such as dimensional requirements, electrical performance requirements, and/or thermal performance requirements, such as a desired operating temperature or temperature range, a required thermal conductivity, etc.

In certain embodiments, the insulation system may include one or more layers of enamel, such as the enamel layer 115 illustrated in FIG. 1. An enamel layer 115 is typically formed by applying a polymeric varnish to the conductor 105 or to an underlying layer (e.g., an underlying semi-conductive layer 110B, an underlying enamel layer, etc.) and then baking the conductor 105 and any applied layers in a suitable enameling oven or furnace. The polymeric varnish typically includes a combination of polymeric material and one or more solvents. A wide variety of techniques may be utilized to apply the varnish. For example, the conductor 105 may be passed through a die that applies the varnish. As another example, the varnish may be dripped or poured onto the conductor 105. Once the polymeric varnish is applied, the solvents are typically evaporated by heat during the cure process for each layer in one or more enameling ovens. As desired, multiple layers of enamel may be applied onto the conductor 105. For example, a first layer of enamel may be applied, and the conductor 105 along with the applied first layer of enamel may be passed through an enameling oven. A second layer of enamel may then be applied, and the conductor 105 and applied layers may make another pass through the enameling oven (or a separate oven). This process may be repeated until a desired number of enamel coats have been applied and/or until a desired enamel thickness or build has been achieved.

A wide variety of different types of polymeric materials may be utilized as desired to form an enamel layer 115. Examples of suitable materials include, but are not limited to, polyimide, polyamideimide, amideimide, polyester, polyesterimide, polyurethane, polyvinyl formal, polysulfone, polyphenylenesulfone, polysulfide, polyetherimide, polyamide, etc. Additionally, in certain embodiments, an enamel layer 115 may be formed from a mixture of two or more materials, such as two or more of the aforementioned materials. Further, in certain embodiments, different enamel layers may be formed from the same material(s) or from different materials. Additionally, the one or more enamel layers 115 may be formed to have any desired overall thickness or enamel build.

As desired, the insulation system may include one or more suitable wraps, tapes, or yarns (not shown) of insulation materials, such as one or more polymeric tapes and/or glass tapes. For purposes of this disclosure, the term “tape” may be utilized to refer to suitable wraps tapes, and/or yarns. A wide variety of suitable polymeric tapes may be utilized as desired, such as a polyester tape, a polyimide tape, a Kapton® tape (as manufactured and sold by the E.I. du Pont de Nemours and Company), etc. In other ex-ample embodiments, yarns of insulating materials, such as polyester and/or glass yarns, may be wrapped around a conductor 105 and/or any underlying layers. In certain embodiments, additional materials or additives may be incorporated into, embedded into, or adhered to a tape. For example, fluorinated materials (e.g., fluorinated ethylene propylene (FEP), etc.), adhesive materials, and/or any other suitable materials may be applied to a tape and/or embedded into a tape. Additionally, a tape may include a wide variety of suitable dimensions, such as any suitable thickness and/or width. A tape may also be wrapped around a conductor 105 and/or underlying layers formed on the conductor 105 at any suitable angle.

In certain embodiments, the insulation system may include one or more suitable layers of extruded insulation material, such as the extruded, layer 120 illustrated in FIG. 1. An extruded insulation layer 120 may be formed from any suitable materials, such as suitable thermoplastic resins and/or other suitable polymeric materials that may be extruded. Examples of suitable materials that may be extruded as insulation layers or incorporated into extruded layers (e.g., blended with other materials, etc.) include, but are not limited to, polyether-ether-ketone (“PEEK”), polyaryl (“PAEK”), polyester, polyesterimide, polysulfone, polyphenylenesulfone, polysulfide, polyphenylenesulfide, polyetherimide, polyamide, polymeric materials that have been combined with fluorinated materials (e.g., fluorinated PEEK, fluorinated PAEK, etc.) or any other suitably stable high temperature thermoplastic, polymeric material, or other material.

In certain embodiments, a single layer of extruded material may be utilized. In other embodiments, a plurality of extruded layers may be formed via a plurality of extrusion steps. If multiple layers of extruded material are formed, then the various layers may be formed from the same material or combination of materials or, alternatively, at least two layers may be formed from different materials. Indeed, a wide variety of different materials and/or combinations of materials may be utilized to form extruded layers. Additionally, an extruded layer may be formed with any suitable thickness and/or other dimensions. As a few non-limiting examples, an extruded layer may be formed with a thickness between approximately 0.001 inches (25 μm) and approximately 0.024 inches (610 μm), such as a thickness between approximately 0.003 inches (76 μm) and approximately 0.007 inches (178 μm). Further, in certain embodiments, an extruded layer may be formed to have a cross-sectional shape that is similar to that of the underlying conductor 105. In other embodiments, an extruded layer may be formed with a cross-sectional shape that varies from that of the underlying conductor 105.

Although the insulation system is described as including one or more of enamel layer(s), extruded layer(s), and/or tape layers, other types of insulation materials may be utilized as desired in various embodiments. Indeed, a wide variety of suitable insulation structures may be formed on a magnet wire. Additionally, in certain embodiments, application of one or more insulation layers may be controlled to result in a desired concentricity. The concentricity of an insulation layer is the ratio of the thickness of the layer to the thinness of the layer at any given cross-sectional point along a longitudinal length of the magnet wire 100. As desired, the application of an insulation layer may be controlled such that a concentricity of the formed insulation is approximately close to 1.0. For example, an insulation layer may have a concentricity between approximately 1.05 and approximately 1.5, such as a concentricity between approximately 1.1 and approximately 1.3. Additionally, if multiple layers of insulation material are utilized, whether the layers are formed from similar or different materials, the combined insulation layers may have a concentricity between approximately 1.05 and approximately 1.5, such as a concentricity between approximately 1.1 and approximately 1.3. in certain embodiments, an insulation layer or combination of insulation layers may have a concentricity below approximately 1.5, approximately 1.3, or approximately 1.1.

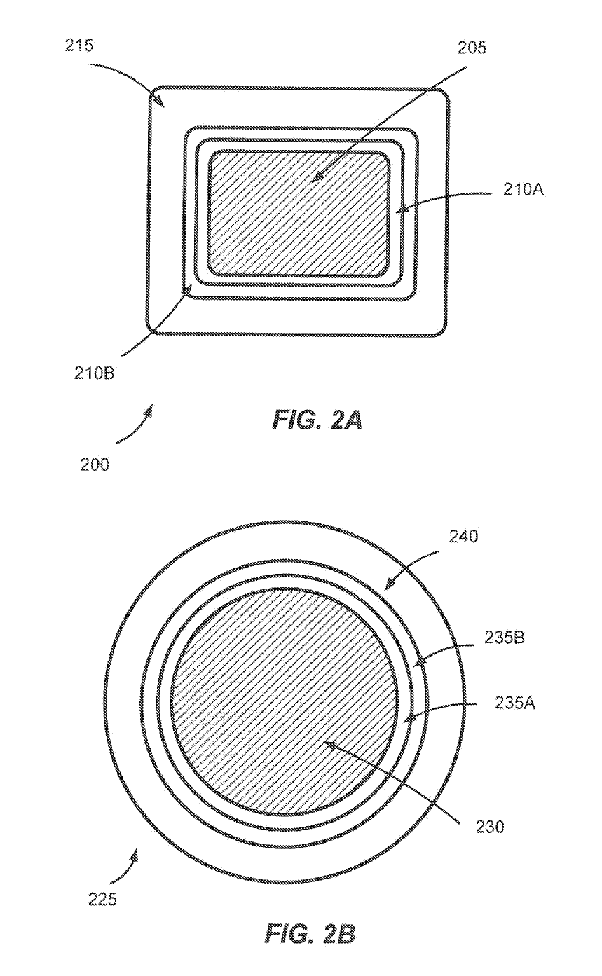

According to an aspect of the disclosure, the magnet wire may additionally include a multi-layer semi-conductive structure 110. The semi-conductive structure 110 may include any number of semi-conductive layers, such as the two layers 110A, 110B illustrated in FIG. 1. As desired in various embodiments, semi-conductive structures may be formed at various positions within a magnet wire. The wire of FIG. 1 illustrates a semi-conductive structure 110 that is formed directly on a central conductor 105. FIGS. 2A and 2B illustrate cross-sectional views of other example magnet wires in which semi-conductive structures are formed directly on a central conductor.

The magnet wire 200 illustrated in FIG. 2A has an approximately rectangular cross-section with rounded corners. A central conductor 205 having an approximately rectangular cross-section may be formed or otherwise provided, and a plurality of semi-conductive layers 210A, 210B and one or more layers of insulation 215 may be formed around the central conductor 205. The semi-conductive layers 210A, 210B may be formed between the central conductor 205 and the insulation layer(s) 215. In certain embodiments, a base semi-conductive layer 210A may be formed directly on or directly around the conductor 205.

The magnet wire 225 illustrated in FIG. 2B has an approximately circular cross-section. A central conductor 230 having an approximately circular cross-section may be fanned or otherwise provided, and a plurality of semi-conductive layers 235A, 235B and one or more layers of insulation 240 may be formed around the central conductor 230. The semi-conductive layers 235A, 235B may be formed between the central conductor 230 and the insulation layer(s) 240. In certain embodiments, a base semi-conductive layer 235A may be fanned directly on or directly around the conductor 230.

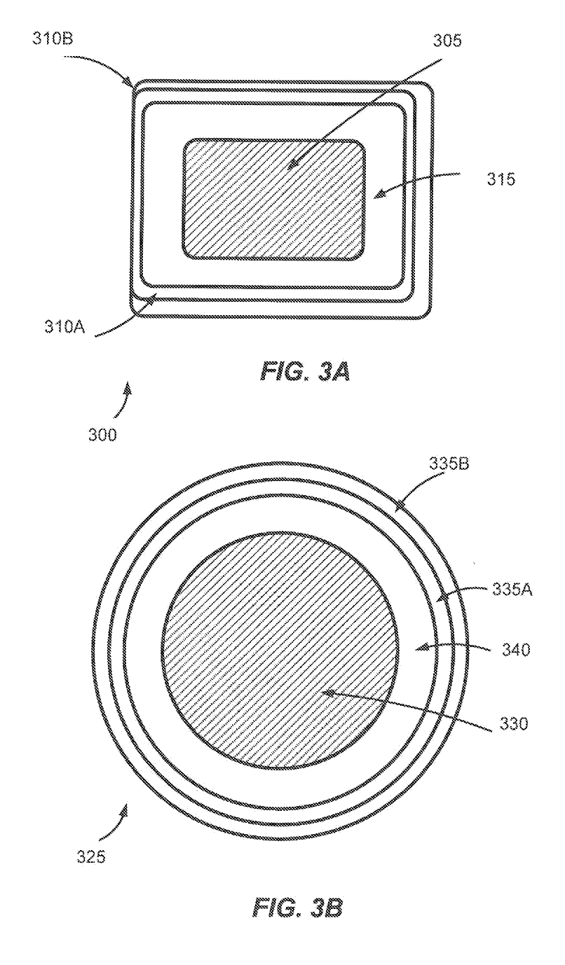

In other embodiments, a semi-conductive structure may be formed as outermost layers on magnet wire. FIGS. 3A and 3B illustrate cross-sectional views of example magnet wires in which semi-conductive structures are formed as outermost layers. Turning first to FIG. 3A, a magnet wire 300 may include a central conductor 305 having an approximately rectangular cross-section with rounded corners, and a plurality at semi-conductive layers 310A, 310B and one or more layers of insulation 315 may be formed around the central conductor 305. The semi-conductive layers 310A, 310B may be formed around the insulation layer(s) 315. For example, an outermost semi-conductive layer 310B may be formed as an outermost layer.

The magnet wire 325 illustrated in FIG. 3B has an approximately circular cross-section. A central conductor 330 having an approximately circular cross-section may be formed or otherwise provided, and a plurality of semi-conductive layers 335A, 335B and one or more layers of insulation 340 may be formed around the central conductor 330. The semi-conductive layers 335A, 335B may be formed around the insulation layer(s) 340. For example, an outermost semi-conductive layer 335B may be formed as an outermost layer.

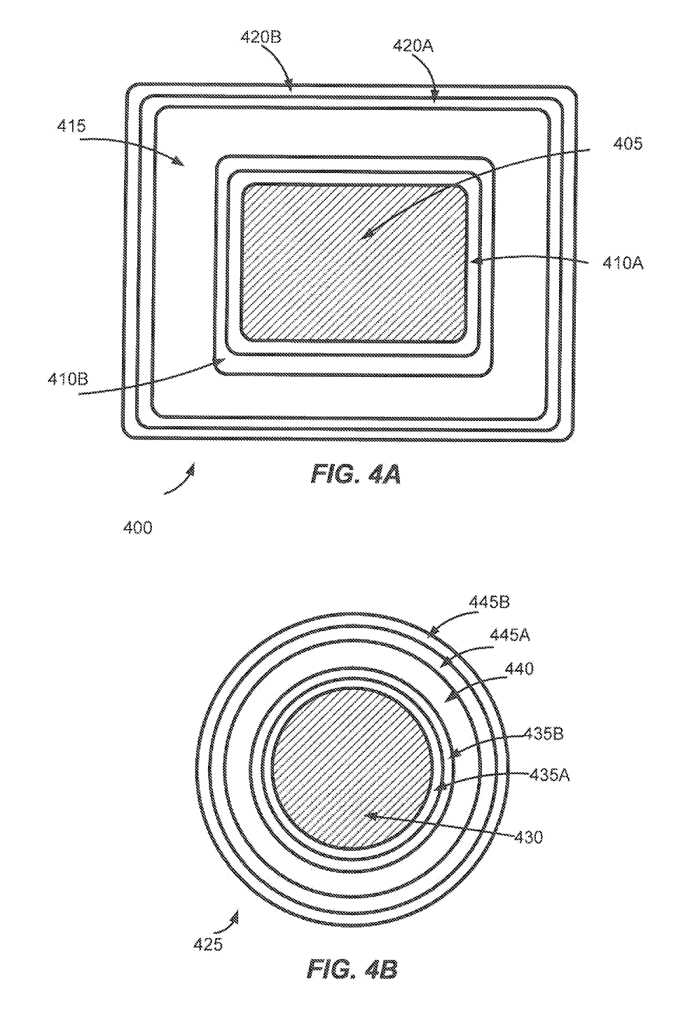

In other embodiments, semi-conductive layers may be formed both directly on a conductor and additionally as one or more outermost layers. FIGS. 4A and 4B illustrate cross-sectional views of example magnet wires in which one or more first semi-conductive layers are formed on a central conductor and one or more second semi-conductive layers are formed as outermost layers. Turning first to FIG. 4A, a magnet wire 400 may include a central conductor 405 having an approximately rectangular cross-section with rounded corners, and one or more semi-conductive layers 410A, 410B may be formed between the conductor 405 and one or more layers of insulation 415. Additionally, one or more semi-conductive layers 420A, 420B may be formed around the layers of insulation 415, for example, as outermost layers. At least one of the one or more inner semi-conductive layers 410A, 41B and the outermost semi-conductive layers 420A, 420B may be formed as a multi-layer semi-conductive structure. In certain embodiments, multi-layer semi-conductive structures may be formed both directly around the conductor and as an outermost layered structure.

The magnet wire 425 illustrated in FIG. 4B has an approximately circular cross-section. The magnet wire 425 may include a central conductor 430, and one or more semi-conductive layers 435A, 435B may be formed between the conductor 430 and one or more layers of insulation 440. Additionally, one or more semi-conductive layers 445A, 445B may be formed around the layers of insulation 440, for example, as outermost layers. At least one of the one or more inner semi-conductive layers 435A, 435B and the outermost semi-conductive layers 445A, 445B may be formed as a multi-layer semi-conductive structure. In certain embodiments, multi-layer semi-conductive structures may be formed both directly around the conductor and as an outermost layered structure.

The various components of the magnet wires illustrated in FIGS. 2A-4B may be similar to those described above with reference to FIG. 1. For example, any of the magnet wires may include a wide variety of suitable types of insulation layers and/or a wide variety of suitable dimensions. Additionally, the magnet wires illustrated in FIGS. 1-4B are provided by way of example only. Other magnet wires may include more or less components than those illustrated. For example, other magnet wires may include alternative conductor constructions (e.g., multiple conductors, etc.), insulation constructions, and/or semi-conductive structures as desired.

A wide variety of suitable methods and/or techniques may be utilized as desired to produce magnet wire in accordance with various embodiments. In conjunction with these manufacturing techniques, a wide variety of suitable equipment, systems, machines, and/or devices may be utilized. These systems, machines, and/or devices may include, but are not limited to, one or more suitable wire formation devices and/or drawing devices (e.g., rod breakdown machines, rod mills, conform devices, wire shaping devices, dies, flatteners, rollers, etc.), one or more annealers, one or more wire cleaning devices, one or more capstans, one or more dancers, one or more flyers, one or more load cells, one or more enameling ovens, one or more tape wrapping devices, one or more extrusion devices (e.g., extrusion heads, extrusion dies, etc.), one or more heating devices, one or more cooling devices (e.g., quenching water baths, etc.), one or more accumulators, one or more take-up devices, and/or one or more testing devices.

In certain embodiments, formation of a magnet wire may include: providing a conductor (e.g., forming a conductor, providing a preformed conductor), optionally applying one or more semi-conductive layers, applying one or more insulation layers (e.g., applying enamel insulation, applying extruded insulation, applying a tape or wrap, etc.), and/or optionally applying one or more outermost semi-conductive layers. According to an aspect of the disclosure, forming one or more semi-conductive layers includes forming a multi-layer semi-conductive structure either directly on the conductor or as outermost layers. In certain embodiments forming one or more semi-conductive layers includes forming a first multi-layer structure directly on the conductor and forming a second multi-layer structure as outermost layers. As desired in certain embodiments, two or more of the operations of the method (up to all of the operations) may be performed in a continuous or tandem process. Accordingly, equipment associated with each operation may be synchronized and/or otherwise controlled in order to facilitate the continuous or tandem processes. For example, motors, capstans, dancers, and/or flyers may be controlled by any number of suitable controllers (e.g., computers, programmable logic controllers, other computing devices) in order to synchronize desired operations.

Regardless of the overall structure of a magnet wire, at least one multi-layer semi-conductive structure may be provided. For purposes of describing the semi-conductive layers, a multi-layer structure will generally be referred to as semi-conductive structure 110 and the various semi-conductive layers will be referred to as semi-conductive layers 110A, 110B, etc. In certain embodiments, as a result of incorporating a semi-conductive structure into a magnet wire 100, it may be possible to increase the partial discharge inception voltage (“PDIV”) and/or dielectric strength of the magnet wire 100. A semi-conductive structure may assist in equalizing voltage stresses in the insulation and/or equalizing or “smoothing out” non-uniform electric fields at or near the conductor and/or at or near a surface of the magnet wire 100. In certain embodiments, the incorporation of one or more semi-conductive may extend the life expectancy of a magnet wire 100 or a winding funned from the wire 100.

In the event that a semi-conductive structure 110 is applied directly on or around a conductor 105, the semi-conductive layers 110A, 110B may equalize or “smooth” non-uniform electric fields within the magnet wire. Imperfections on the surface of the conductor 105, such as burs, dents, slivers of conductive material, foreign contaminants, etc., may lead to non-uniform electric fields. The semi-conductive layers 110A, 110B may improve or mitigate the uniformity of the electric fields when the conductor 105 is electrified. As a result, the semi-conductive layers 110A, 110B may function as a buffer for the insulating structure (e.g., insulation layers) of the magnet wire 100. The buffering and/or smoothing effects may be relatively higher for the innermost insulating material and/or insulating layers, which typically are under greater electrical stress relative to other insulating layers.

In the event that a semi-conductive structure 110 is applied as outermost layers, these outermost semi-conductive layers may assist in equalizing certain, electric fields that impact the magnet wire 100. For example, relatively high stress local electric fields may be caused as a result of the magnet wire 100 coming into contact with uneven surfaces of external components (e.g., a motor housing, a stator, grounded components or parts, etc.) and/or external components having different electrical potentials. The semi-conductive layers may assist in containment of the electrical field of the energized magnet wire inside the magnet wire insulation. Additionally, the semi-conductive layers may assist in preventing the development of surface tracking. In other words, the semi-conductive layers may help to equalize or “smooth” the effect of non-uniform external electric fields.

A semi-conductive layer, such as semi-conductive layer 110A, may be formed from a wide variety of suitable materials and/or combinations of materials. For example, a semi-conductive layer 110A may be formed as a semi-conductive enamel layer. In other words, semi-conductive material may be dispersed or blended into an enamel varnish or other base material(s) that are applied and further cured (e.g., baked, etc.) to form a semi-conductive enamel layer. In other embodiments, a semi-conductive polymeric extrusion (e.g., an extruded thermoplastic or other polymer that includes dispersed or blended semi-conductive material, etc.), or as a semi-conductive tape or wrap may be utilized to form a semi-conductive layer. In yet other embodiments, a semi-conductive polymeric material may be utilized to form a semi-conductive layer. In other words, a polymeric material that exhibits semi-conductive properties may be utilized. As desired, any combination of materials and/or constructions may be utilized to form a semi-conductive layer and/or a plurality of semi-conductive layers.

In certain embodiments, a semi-conductive layer may be formed from a material that combines one or more suitable filler materials with one or more base materials. For example, semi-conductive and/or conductive filler material may be combined with one or more suitable base materials, Examples of suitable filler materials include, but are not limited to, suitable inorganic materials, such as carbon black, metallic materials, and/or metal oxides (e.g., zinc, copper, aluminum, nickel, tin oxide, chromium, potassium titanate, etc.); suitable organic materials such as polyaniline, polyacetylene, polyphenylene, polypyrrole; other electrically conductive particles; and/or any suitable combination of materials. The particles of the filler material may have any suitable dimensions, such as any suitable diameters. In certain embodiments, the filler material may include nanoparticles.

Examples of suitable base materials may include, but are not limited to, polyimide, polyamidcimide, amideimide, polyester, polyesterimide, polysulfone, polyphenylenesulfone, polysulfide, polyphenylenesulfide, polyetherimide, polyamide, PEEK, PAEK, thermoplastic resin materials, polymeric tapes, and/or any other suitable material. Further, any suitable blend or mixture ratio between filler material(s) and base material(s) may be utilized. For example, a semi-conductive layer 110A may include by between approximately 0.1 percent and approximately 10.0 percent of filler material(s) by weight, although other concentrations may be used (e.g., between approximately 0.1 percent and approximately 50.0 percent, between approximately 7.0 percent and approximately 20.0 percent, between approximately 5.0 percent and approximately 15.0 percent, etc.).

In certain embodiments, semi-conductive properties of organic polymers may be achieved by dispersing, semi-conductive or conductive solid particles into one or more insulation materials and/or by “doping” an insulation material. The concentration of the conductive particles (e.g., black carbon, etc.) is typically in the range of approximately 0.1% to approximately 10.0%. This process may be further advanced or fine-tuned by using organic synthesis and/or by additional sophisticated dispersion techniques.

In certain semi-conductive structures, each semi-conductive layer may be formed from similar materials and/or combinations of materials. For example, each semi-conductive layer may be formed with the same filler material(s) added to the same base material(s). As desired, filling ratios may vary between two or more semi-conductive layers. In this regard, different semi-conductive layers may have different conductivities. In other embodiments, at least two layers of a semi-conductive structure may be formed from different materials and/or combinations of materials. For example, different filler materials and/or base materials may be utilized.

As desired, the semi-conductive properties of a semi-conductive layer may be characterized by either a volume resistivity or corresponding volume conductivity or, alternatively by a surface resistivity or corresponding surface conductivity. Typically, a semi-conductive layer has a volume conductivity (σ) between approximately 10⁻⁸ Siemens per centimeter (S/cm) and approximately 10³ S/cm at approximately 20 degrees Celsius (° C.). In certain embodiments, a semi-conductive layer has a volume conductivity between approximately 10⁻⁶ S/cm and approximately 10² S/cm at approximately 20° C. As such, a semi-conductive layer typically has a volume resistivity (ρ) between approximately 10⁻³ Ohm centimeters (Ω·cm) and approximately 10⁸ Ω·cm at approximately 20° C. In certain embodiments, a semi-conductive layer may have a volume resistivity (ρ) between approximately 10⁻² Ω·cm and approximately 10⁶ Ω·cm at approximately 20° C. such as a volume resistivity (ρ) between approximately 10⁻¹ Ω·cm and approximately 10⁵ Ω·cm at approximately 20° C.

In certain embodiments, the values of surface resistivity of a semi-conductive layer range from approximately 10⁻¹ Ω per square to approximately 10⁶ Ω per square. For example, a surface resistivity of a semi-conductive layer may be between approximately 10¹ Ω per square and approximately 10⁵ Ω per square. It is noted that parameters such as volume conductivity, volume resistivity, surface conductivity, and surface resistivity may be evaluated and utilized based at least in part on the positioning of a semi-conductive structure 110 within a magnet wire 100. For example, with internal semi-conductive structures formed directly on a conductor 105, the consideration of volume conductivity or resistivity may be more relevant. Conversely, with semi-conductive structures formed as outermost layers, the consideration of surface conductivity or resistivity may be more relevant.

As desired in various embodiments, various layers within a semi-conductive structure 110 may have a wide variety of differences in conductivities, ranging from approximately 10⁴ S/cm to approximately 10⁻⁸ S/cm. For example, a ratio between the conductivity of a first semi-conductive layer and a second semi-conductive layer having a lower conductivity may be on a scale of 100,000,000,000:1, 10,000,000,000:1 1,000,000,000:1, 100,000,000:1, 10,000,000:1, 1,000,000:1, 100,000:1, 10,000:1, 1,000:1, 100:1, 10:1, 5:1, 2:1, or some other suitable value. These ratios are applicable to various semi-conductive layers incorporated into inner semi-conductive structures (i.e., a semi-conductive structure formed directly around a conductor) or outer semi-conductive structures. In certain embodiments, the consideration of suitable semi-conductive materials for semi-conductive structures from a conductive value point of view is based at least in part on identifying conductivities that would as seamlessly as possible provide smoother transition between the relatively high conductivity of the conductor and the relatively low conductivity of the insulating structure. However, the process of selecting these semi-conductive materials may additionally and, in some cases, more importantly be based at least in part on considerations for thermal, mechanical and other electrical properties of the semi-conductive materials and their suitability to meet required performance parameters for the magnet wire.

Each semi-conductive layer may be formed with any suitable thickness. For example, a semi-conductive layer may have a thickness between approximately 0.0005 inches (13 μm) and approximately 0.003 inches (76 μm). In certain embodiments, a semi-conductive layer may have a thickness of approximately 0.0005 inches (13 μm), 0.001 inches (25 μm), 0.0015 inches (38 μm), 0.002 inches (51 μm), 0.0025 inches (64 μm), 0.003 inches (76 μm), or any value included in a range between two of the above stated values. In yet other embodiments, a semi-conductive layer may have a thickness that is less than approximately 0.005 inches (127 μm), 0.003 inches (76 μm), 0.002 inches (51 μm), or 0.001 inches (25 μm).

Similarly, a multi-layer semi-conductive structure 110 may have any desired overall thickness or build. For example, a semi-conductive structure 110 may have a thickness between approximately 0.0001 inches (3 μm) and approximately 0.010 inches (254 μm). In certain embodiments, a semi-conductive structure 110 may have a thickness of approximately 0.0001 inches (3 μm), approximately 0.0005 inches (13 μm), 0.001 inches (25 μm), 0.002 inches (5 μm), 0.003 inches (76 μm), 0.004 inches (102 μm), 0.005 inches (127 μm), 0.006 inches (152 μm), 0.007 inches (178 μm), 0.008 inches (203 μm), 0.009 inches (229 μm), 0.010 inches (254 μm), or any value included in a range between two of the above values. In yet other embodiments, a semi-conductive structure 110 may have a thickness that is less than approximately 0.010 inches (254 μm), 0.008 inches (203 μm), 0.005 inches (127 μm), 0.003 inches (76 μm), 0.002 inches (51 μm), 0.001 inches (25 μm), or 0.0005 inches (13 μm).

Additionally, a semi-conductive layer and/or an overall semi-conductive structure 110 may be formed with any desired concentricity, such as a concentricity between approximately 1.05 and approximately 1.5. In certain embodiments, a semi-conductive layer or semi-conductive structure 110 may have a concentricity between approximately 1.1 and approximately 1.3. In other embodiments, a semi-conductive layer or semi-conductive structure 110 may have a concentricity below approximately 1.5, approximately 1.3, or approximately 1.1.

It should be noted that semi-conductive layers may be relatively mechanically weaker compared to insulating layers that do not contain any conductive or semi-conductive components. Typically, the increase in conductivity will result in weakening the mechanical performance of the wire, including adhesion and flexibility (e.g., modulus of elasticity, etc.). Accordingly, certain characteristics of a semi-conductive layer, such as thickness and/or a ratio of conductive to non-conductive material, may be controlled in order to achieve a magnet wire with one or more desired performance characteristics. Typically, the magnet wire is optimized to form a compromise between desired electrical performance and required or desired mechanical performance.

According to an aspect of the disclosure, at least two semi-conductive layers incorporated into a semi-conductive structure 110 may have different conductivities or resistivities. For example, with a semi-conductive structure 110 formed directly on a conductor, a first semi-conductive layer may have a first conductivity, and a second semi-conductive layer formed around the first semi-conductive layer may have a second conductivity that is lower than the first conductivity. In certain embodiments, as successive semi-conductive layers are formed around the conductor 105, each semi-conductive layer may have a conductivity that is either equal to or less than an underlying layer on which it is formed. For example, the conductivities of successive semi-conductive layers may decrease as the layers are formed around the conductor. Such an approach permits a wide variety of conductivity transitions between the conductor and an insulating structure.

With a semi-conductive structure 110 formed as outermost layers of a magnet wire 100, a first semi-conductive layer may have a first conductivity, and a second semi-conductive layer formed around the first semi-conductive layer may have a second conductivity that is greater than the first conductivity. In certain embodiments, as successive semi-conductive layers are formed around the conductor 105, each semi-conductive layer may have a conductivity that is either equal to or greater than an underlying layer on which it is formed. For example, the conductivities of successive semi-conductive layers may increase as the layers are formed around the conductor. Such an approach permits a wide variety of conductivity transitions between an external component and an insulating structure.

Based at least in part on the materials used, the equalizing or “smoothing out” effect of different types of semi-conductive layers may be achieved in different ways. For example, with semi-conductive enamels and/or extruded polymers, the equalizing effect may be facilitated by filling, flooding, or smoothing the dents (i.e., valleys, etc.), burs (i.e., peaks, etc.) and other imperfections that may be present in a conductor's surface. As another example, for semi-conductive tapes, the filling of the surface dents, burs, and other imperfections in the conductor's surface may not be required and the equalizing effect may be determined based at least in part on the quality of the tape (i.e. the smoothness and conductivity of the outer surface), the thickness of the tape, and/or the type and/or quality of overlap between consecutive wraps of the tape. Even if gaseous cavities are formed between the conductor and the tape as a result of the application of a semi-conductive tape, there may be no associated detrimental effects that can inadvertently affect the integrity of the insulation.

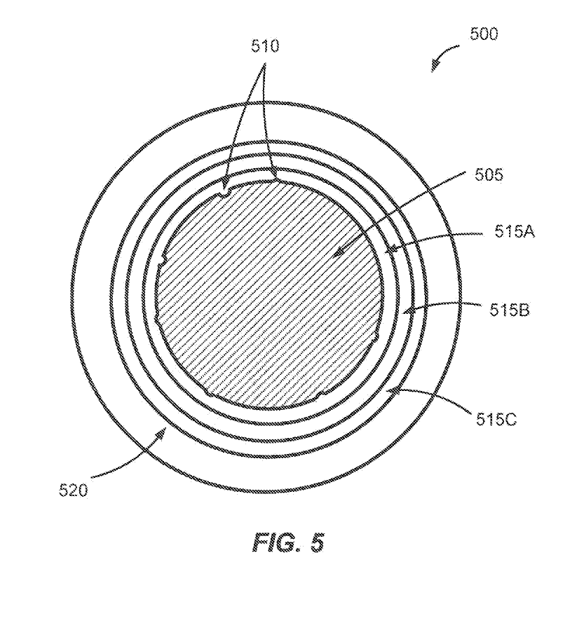

FIG. 5 depicts an example magnet wire cross-section in which inconsistencies are present on the surface of the conductor, The magnet wire 500 includes a conductor 505, and one or more inconsistencies (e.g., dents, burs, etc.) 510 are illustrated as raised and/or lowered areas on the conductor 505. A plurality of semi-conductive layers 515A, 515B, 515C are applied or formed around the conductor 505, and one or more insulation layers 520 are then formed around the semi-conductive layers 515A-C. The semi-conductive layers 515A-C may closely conform to the inconsistencies. For example, if a semi-conductive layer (generally referred to as layer 515) is applied as an enamel layer or as an extruded layer, the layer 515 will fill any dents and smooth out the surface over any burs. As another example, if a layer 515 is applied as a semi-conductive wrap or tape, the layer 515 may also at least partially fill any dents and smooth out the surface over any burs. The wrap may also form a uniform electro-potential layer over any imperfections, which will “smooth out” and/or “neutralize” the local electrical field in the insulating structure applied through the wrap or tape.

Regardless of the type of semi-conductive layers utilized, the overall semi-conductive structure may assist in equalizing or “smoothing out” the effects of electric fields caused by the inconsistencies 510 on the conductor surface, thereby improving the overall performance of the magnet wire insulation system. The plurality of consecutively formed semi-conductive layers 515A-C may gradually decrease gradients in the electric field distribution, thereby creating a more favorable electric stress condition at the interface between an outermost semi-conductive layer 515C and an innermost insulating layer 520. In other words, the overall distribution of the electric field across the magnet wire 500 may become more uniform both across the semi-conductive. structure and, more importantly, within the insulation structure. As an electric field gradually transitions between the relatively high conductivity of the conductor 105 and the relatively low conductivity of an insulating structure, the various layers of a multi-layer semi-conductive structure may improve the distribution of the electric field across the semi-conductive structure and the insulation structure.

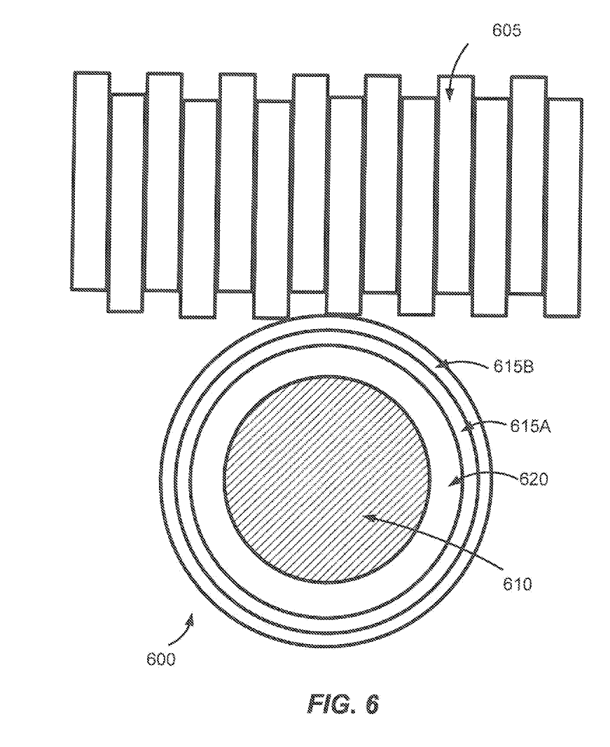

FIG. 6 illustrates an example magnet wire cross-section in which outermost semi-conductive layers are provided. The magnet wire 600 may be in contact with an external component 605, such as a stator or the housing of an electric machine. Additionally, the magnet wire 600 may include a conductor 610 and one or more insulation layers 620 may be formed around the conductor 610. A plurality of semi-conductive layers 615A, 615B may then be formed around the insulation layer(s) 620. These outermost layers 615A, 615B may assist in equalizing local electric fields that impact performance of the magnet wire. For example, the outermost layers 615A, 615B may gradually decrease gradients of electric fields caused by the magnet wire 600 coming into contact with uneven surfaces of the external component 605 and/or by the external component 605 having different electrical potentials.

Because the external component 605 is typically grounded, non-uniform electric fields may be present at various points across the insulating structure of the magnet wire. The role of the semi-conductive layers 615A, 615B on the outmost surface of the insulated magnet wire is containment of the electrical field of the energized wire inside the insulation and/or prevention in the development of surface tracking at the exits of the magnet wire 600 from the external component. In other words, the outermost semi-conductive layers 615A, 615B may help to equalize or “smooth out” the effect of non-uniform external, electric fields. Additionally, as desired, an additional specially designed semi-conductive voltage grading system may be applied at the termination of both ends of any section of the magnet wire 600. The role of such a system is to limit or prevent the development of electric surface tracking across the insulating structure between the conductor 610 and the outer semi-conductive structure. If such a voltage grading system is not applied at both ends of the magnet wire 600, electric failure of the wire 600 may occur.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An insulated winding wire comprising;
a conductor;
a plurality of adjacent semi-conductive layers formed around the conductor, wherein at least two of the plurality of semi-conductive layers have different conductivities; and
at least one layer of dielectric material formed around the conductor.

2. The insulated winding wire of claim 1, wherein the plurality of adjacent semi-conductive layers is formed between the conductor and the dielectric material.

3. The insulated winding wire of claim 2, wherein a first of the plurality of semi-conductive layers comprises a first conductivity and a second of the plurality of semi-conductive layers comprises a second conductivity lower than the first conductivity, and
wherein the first semi-conductive layer is formed closer to the conductor than the second semi-conductive layer.

4. The insulated winding wire of claim 1, wherein the plurality of adjacent semi-conductive layers is formed around the dielectric material.

5. The insulated winding wire of claim 4, wherein a first of the plurality of semi-conductive layers comprises a first conductivity and a second of the plurality of semi-conductive layers comprises a second conductivity lower than the first conductivity, and
wherein the first semi-conductive layer is formed as an outermost layer of the insulated winding wire.

6. The insulated winding wire of claim 1, wherein each of the plurality of semi-conductive layers comprises one of (i) a semi-conductive enamel layer, (ii) an extruded semi-conductive layer, or (iii) a semi-conductive tape.

7. The insulated winding wire of claim 1, wherein at least one of the plurality of semi-conductive layers comprises one of (i) carbon black (ii) metallic filler, or (iii) a semi-conductive polymer.

8. The insulated winding wire of claim 1, wherein each of the plurality of semi-conductive layers has a thickness between approximately 0.0001 inches and approximately 0.01 inches.

9. The insulated winding wire of claim 1, wherein the plurality of semi-conductive layers function to equalize a non-uniform electric field caused by an imperfection of a surface of the conductor.

10. An insulated winding wire comprising:
a conductor;
a first layer of semi-conductive material formed around the conductor and having a first conductivity;
a second layer of semi-conductive material formed around the first layer of semi-conductive material and having a second conductivity lower than the first conductivity; and
at least one layer of insulation material formed around the second layer of semi-conductive material.

11. The insulated winding wire of claim 10, wherein the first layer of semi-conductive material is formed directly around the conductor.

12. The insulated winding wire of claim 10, wherein at least one of the first layer of semi-conductive material or the second layer of semi-conductive material comprises one of (i) a semi-conductive enamel layer, (ii) an extruded semi-conductive layer, or (iii) a semi-conductive tape.

13. The insulated winding wire of claim 10, wherein at least one of the first layer of semi-conductive material or the second layer of semi-conductive material comprises carbon black.

14. The insulated winding wire of claim 10, wherein at least one of the first layer of semi-conductive material or the second layer of semi-conductive material comprises a metallic filler.

15. The insulated winding wire of claim 10 wherein at least one of the first layer of semi-conductive material or the second layer of semi-conductive material has a thickness between approximately 0.0001 inches and approximately 0.01 inches.

16. The insulated winding wire of claim 10, wherein the first and second layers of semi-conductive material function to equalize a non-uniform electric field caused by an imperfection on a surface of the conductor.

17. The insulated winding wire of claim 10, wherein the first layer of semi-conductive material is formed from a first combination of one or more materials and the second layer of semi-conductive material is formed from a second combination of one or more materials different than the first combination.

18. The insulated winding wire of claim 10, further comprising:
a third layer of semi-conductive material formed around the insulation material and having a first conductivity;
a fourth layer of semi-conductive material formed around the third layer of semi-conductive material and having a fourth conductivity that is higher than the third conductivity;

19. The insulated winding wire of claim 10, wherein the at least one layer of insulation material comprises at least one of (i) an enamel layer, (ii) an extruded thermoplastic layer, or (iii) a tape.

20. A method for forming an insulated winding wire, the method comprising:
providing a conductor;
forming a first layer of semi-conductive material around the conductor, the first layer of semi-conductive material having a first conductivity;
forming a second layer of semi-conductive material around the first layer of semi conductive material, the second layer of semi-conductive material having a second conductivity lower than the first conductivity; and
forming at least one layer of insulation material around the second layer of semi-conductive material.
